(19) United States
(12) Patent Application Publication
(10) Pub. No.: US 2026/0342886 A1
(43) Pub. Date: Oct. 29, 2026

(54) PROXY UNIFIED DATA REPOSITORY SYSTEM AND METHOD

(71) Applicant: T-Mobile Innovations LLC, Overland Park, KS (US)

(72) Inventors: Subramania KAUSHIK, Bellevue, WA (US); Anil Kumar MARIYANI, Ashburn, VA (US)

(21) Appl. No.: 19/192,630

(22) Filed: Apr. 29, 2025

(51) Int. Cl. H04L 67/566; H04L 67/02; H04W 76/10

(52) U.S. Cl. CPC H04L 67/566; H04L 67/02; H04W 76/10

(57) ABSTRACT

A proxy UDR system and method are provided. The system includes a proxy unified data repository (UDR) system facilitating communication between an application external to a network and a UDR. The system further includes an application program interface (API) enabling communication between the proxy UDR system and the application external to the network using and an additional API enabling communication between the proxy UDR system and the UDR.

### TECHNICAL BACKGROUND

As wireless networks evolve and grow, there are ongoing challenges in communicating data across different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer fifth generation (5G) and millimeter wave (mm-wave) networks, as well as fourth generation (4G) long-term evolution (LTE) access nodes. 5G networks include a core network utilizing a service based architecture (SBA) with multiple network functions (NFs). The NFs utilize a Unified Data Repository (UDR) for storage of data. The UDR may store application data, subscription data, authentication data, service authorizations, policy data, and session binding and application state information. The UDR may also be utilized within 4G networks and other radio access technologies (RATs) for data storage and the UDR may interact with NFs in these networks in a similar manner.

With 5G, the third generation partnership (3GPP) has defined standards for 5G UDR interfaces. However, the telecommunications world, applications and clients as well as specific use cases require access to data stored within the UDR and are unable to leverage the standards defined in 3GPP.

### OVERVIEW

Exemplary embodiments provided herein include a method for utilizing a proxy unified data repository (UDR). The method includes deploying the proxy UDR for facilitating communication between an application and a UDR. The method further includes enabling communication between the proxy UDR and the application using an application program interface (API) and enabling communication between the proxy UDR and the UDR using at least an additional API.

Embodiments disclosed herein further include a proxy UDR system. The proxy UDR system facilitates communication between an application and a UDR. The proxy UDR system further includes an application program interface (API) enabling communication between the proxy UDR system and the application and an additional API enabling communication between the proxy UDR system and the UDR.

Embodiments disclosed herein include a proxy UDR system facilitating communication between an application external to a network and a UDR. The system further includes a lightweight directory access protocol (LDAP) application program interface (API) providing a first set of services for the application external to the network and a hypertext transfer protocol version two (HTTP2) representational state transfer (REST) API providing a second set of services for the application external to the network.

Further embodiments include non-transitory computer readable mediums and processing nodes performing the operations described above and further operations described herein.

### BRIEF DESCRIPTION OF THE DRAWINGS

FIG. 1 depicts an exemplary environment for a proxy unified data repository (UDR) system in accordance with an embodiment.

FIG. 2 depicts a proxy UDR system in accordance with an embodiment.

FIG. 3 depicts an environment for a proxy UDR system in accordance with an embodiment.

FIG. 4 depicts an environment for operation of a proxy UDR system in accordance with an embodiment.

FIG. 5 depicts an exemplary method for implementing a proxy UDR system in accordance with an embodiment.

FIG. 6 depicts an exemplary method for utilizing a proxy UDR system to pull information from a UDR in accordance with an embodiment.

FIG. 7 depicts a further exemplary method for utilizing a proxy UDR system to push information to a requestor.

### DETAILED DESCRIPTION

In embodiments disclosed herein, a proxy unified data repository (UDR) system is provided for facilitating communication with a UDR. The UDR is a converged repository used to store data utilized by network functions and applications including external applications. Existing UDR systems provide interfaces, such as the network data repository interface (Nudr), which allow the UDR to communicate with other network functions (NFs). However, the existing interfaces do not provide full access for external applications and other specific use cases that require access to the UDR. Current standards based solutions do not allow for direct communication of external applications or certain specific use cases, such as basic service sets (BSS), with the entire contents of the UDR.

Accordingly, no generic application program interfaces (APIs) are available for direct communication with UDR by external applications and other specific use cases. Access to telecommunications subscriber data stored in the UDR, which may for example include 4G, 5G, and/or 6G UDRs, is often requested by telecommunications information technology applications and other enterprise and/or network solutions. Currently, the access is generally limited to a partial or very small set of attributes of the entire subscriber profile in UDR.

Accordingly, in embodiments disclosed herein, a proxy UDR system incorporating multiple APIs for facilitating communication of applications with the UDR is provided. For example, hypertext transfer protocol version two (HTTP2) representational state transfer (REST) APIs and/or lightweight directory access protocol (LDAP) APIs may be provided. The REST API and LDAP API can be used to look up information or devices within a network and simplify access to internal resources, such as the UDR. The REST and LDAP APIs can be made available to fetch subscriber information. HTTP/2 enables efficient use of network resources and a reduced perception of latency by introducing header field compression and allowing multiple concurrent exchanges on the same connection. HTTP/2 also introduces an unsolicited push of representations from servers to clients.

Thus, with the structure described herein, the proxy UDR system has ability to serve various clients or applications. These include, for example, policy functions, voice mail retrieval (VMR) applications, gateway mobile location center (GMLC), device query interface (DQI), network application publisher (NAP), and the network exposure function (NEF) and/or service capability exposure function (SCEF). While the NEF and SCEF are NFs and can generally communicate with the UDR over 3GPP defined interfaces, unique database queries from the NEF or SCEF may be supported through the proxy UDR and LDAP and REST APIs. The aforementioned clients and applications can integrate with the UDR proxy system directly or via any load balancers (e.g. F5, A10 etc.).

In operation, upon receiving a request, the proxy UDR system locates the subscriber, performs a query, and provides a response to the requestor. In structures having multiple UDR deployments (two or more segmented databases) with a large subscriber base, such as millions or more, the proxy UDR system may have the ability to perform queries based on a built-in subscriber look up function to match the request with the proper subscriber segment and provide responses to the requestor.

In embodiments provided herein, the proxy UDR system provides LDAP interfaces supporting various use cases including LDAP authentication, binding and unbinding, and LDAP search, modify, add, and delete. Further, the LDAP API may support all of the above use cases over transport layer security (TLS). Additionally, in embodiments provided herein, the proxy UDR system includes one or more HTTP/2 REST API interfaces supporting various HTTP operations, which may include: Get; Put; Patch; Post; and Delete operations.

In addition to the systems and methods described herein, non-transitory computer-readable mediums may store the operations for the instructions or methods. Further, processing nodes on the network may execute the instructions or methods. The processing node may include a processor included in the proxy UDR system and/or a processor included in any controller node in the wireless network.

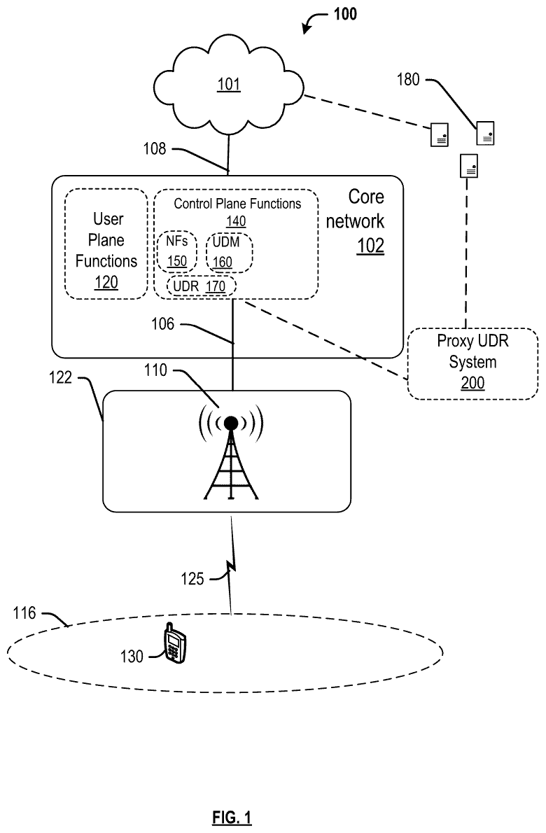

FIG. 1 depicts an exemplary environment 100 for implementing a proxy UDR system 200. Environment 100 comprises a communication network 101, core network 102, and a radio access network (RAN) 122 including at least an access node 110. Wireless device 130 is located in a coverage area 116 and communicates with the access node 110 over communication link 125. Although only one wireless device 130 is shown, it should be understood that any number of wireless devices could be included. The proxy UDR system 200 interacts with the core network 102, which includes control plane functions 140 and user plane functions 120. Specifically, in the 5G environment, the proxy UDR system 200 enables communications between applications or clients 180 and a UDR 170 of the core network 102.

In the illustrated environment, the core network 102 includes an SBA architecture, in which service-based interfaces may be utilized between control plane functions 140, while multiple UPFs 120 connect over point-to-point link. The UPF 120 accesses a data network, such as network 101, and performs operations such as packet routing and forwarding, packet inspection, policy enforcement for the user plane, quality of service (QoS) handling, etc. The control plane functions 140 include, for example, multiple network functions (NFs) 150, a unified data management (UDM) 160 and a unified data repository (UDR) 170. The NFs 150 may access the UDR 170 through the UDM 160 or in some cases, may access the UDR 170 directly. The NFs 150 are shown generally and the specific NFs are omitted for simplification of description.

The UDM 160 may be described as a front-end part of the UDR 170. The UDM 160 makes subscription-related data available to the different NFs 150 at their request. It supplies the information to the NFs 150 and operates similarly to the home subscriber server (HSS) in 4G networks.

The UDR 170 acts as a database for the core network 102. The UDR 170 stores at least four different types of subscription-related information including: subscription data; policy data; structured data for exposure; and application data. While the subscription data is available via the UDM 160 to most NFs, in embodiments provided herein, external applications and/or clients access the UDR 170 through the proxy UDR system 200.

The proxy UDR system 200 interacts with applications or clients 180, which may be external to the core network 102. The proxy UDR system 200 offers access to the UDR 170 by the clients or applications 180 as no direct access is given to the applications or clients 180 to the UDR 170 via 3GPP supported interfaces. Thus, the proxy UDR system 170 provides single source of entry for external API database queries. Further, efficient load balancing, security and other database protection mechanisms can be implemented on the proxy UDR system 200.

The external clients or applications 180 may be or include policy functions, voicemail routing (VMR), gateway mobile location center (GMLC), device query interface (DQI), and/or network application publisher (NAP). Further, the network exposure function (NEF) and/or service capability exposure function (SCEF) may access the proxy UDR system 200 over a non-3GPP interface to support unique database queries. Further, the applications or clients may include any external or internal information technology application. Additionally, basic service set (BSS) use cases involving a group of wireless devices using a single access point may access the UDR 170 through the proxy UDR system 200. The BSS is identified by a unique basic service set identifier (BSSID). The external clients or applications 180 are shown as communicating with the proxy UDR system 200 and the data network 101, but may alternatively communicate over wireless link 125 or in any other manner.

The RAN 122 can include various access network functions and devices disposed between the core network 102 and the end-user wireless device 130. For example, the RAN 122 includes at least an access node (or base station), such as an eNodeB and/or a next generation NodeB (gNodeB) 110 communicating with an end-user wireless device 130. Further, either of core network 102 and radio access network 122 can include one or more of a local area network, a wide area network, and an internetwork (including the Internet) and be capable of communicating signals and carrying data, for example, to support voice, push-to-talk, broadcast video, and data communications by end-user wireless device 130.

Access node 110 can be any network node configured to provide communication between end-user wireless device 130 and communication network 101, including standard access nodes and/or short range, low power, small access nodes. For instance, access node 110 may include any standard access node, such as a macrocell access node, base transceiver station, or a radio base station, or the like. In embodiments further discussed herein, the access node 110 is a next generation NodeB (gNB). However, the access node 110 may include multiple co-located access nodes, such as a combination of eNodeBs and gNodeBs. Access node 110 can be a small access node including a microcell access node, a picocell access node, a femtocell access node, or the like such as a home NodeB or a home eNodeB device. Moreover, it is noted that while access node 110 and wireless device 130 are illustrated in FIG. 1, any number of access nodes and wireless devices can be implemented within

### Environment 100.

As further described herein, by utilizing antennas, access node 110 can deploy a wireless air interface 125 using one or more frequency bands over one or more coverage areas 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless device 130 may be any device, system, combination of devices, or other such communication platform capable of communicating wirelessly with access node 110 using one or more frequency bands deployed therefrom. Wireless devices 130 may be or include devices that subscribe to various services available through a wireless network. Wireless device 130 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. The wireless device 130 can be end-user wireless devices (e.g., user equipment (UEs)) utilizing communication link 125, which may operate based on 6G, 5G new radio (NR), 4G long term evolution (LTE), or any other suitable type of radio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 130. Wireless network protocols can comprise multimedia broadcast multicast services (MBMS), code division multiple access (CDMA) single-Carrier radio transmission technology(1xRTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path-including combinations thereof. Communication link 106 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol as described herein. Communication link 106 can be a direct link or might include various equipment, intermediate components, systems, and networks. Communication links 106 may comprise many different signals sharing the same link.

Other network elements may be present in environment 100 to facilitate communication but are omitted for clarity, such as network functions, base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access node 110 and communication network 101.

Further, the methods, systems, devices, networks, network functions, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

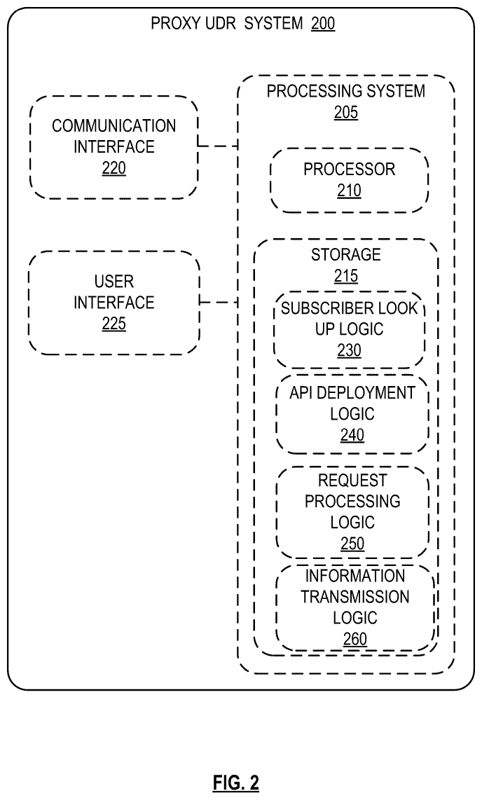

FIG. 2 illustrates a proxy UDR system 200 in accordance with embodiments described herein. The components described herein are merely exemplary as many different configurations for the proxy UDR system 200 may be implemented. The proxy UDR system 200 may be configured to perform the methods and operations disclosed herein to interact with applications or clients 180 as well as specific use cases through a non-3GPP interface. In the disclosed embodiments, the proxy UDR system 200 may be integrated with the core network 102 or may be an entirely separate component capable of communicating with at least the UDR 170 of the core network 102. Further, the components of the proxy UDR system 200 may be distributed so that one or more components are located within the core network 102 and/or a separate processing node in communication with or integrated with the core network 102.

The proxy UDR system 200 may be configured for performing the operations described herein utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, subscriber look up logic 230 may be operable to ensure that the proxy UDR system is able to locate a subscriber or a corresponding subscriber segment in the UDR 170. Further, API deployment logic 240 may be operable to deploy APIs for communication with the applications or clients 180 and the UDR 170. More specifically, the API deployment logic 240 deploys interfaces on LDAP and/or HTTP/2 REST APIs. The request processing logic 250 receives requests from the external applications or clients 180 to access the UDR 170 and processes the requests, e.g., by triggering the subscriber look up logic 230. Finally, information transmission logic 250 is operable to allow the proxy UDR system 200 to pull information from the UDR 170 and transmit the information to the requesting application or client 180. Further, the information transmission logic 250 may be operable to trigger a push notification from the UDR 170.

To perform the above-described operations, the subscriber look up logic 240, the API deployment logic 240, the request processing logic 250, and the information transmission logic 260 may be executed by the processor 210 to manage information retrieval on behalf of the applications or clients 180 from the UDR 170.

Processor 210 may be a microprocessor and may include hardware circuitry and/or embedded codes configured to retrieve and execute software stored in storage device 215. The proxy UDR system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the proxy UDR system 200 and receive data or information from other system components. User interface 225 may include hardware components, such as touch screens, buttons, displays, speakers, etc. The proxy UDR system 200 may further include other components such as a power management unit, a control interface unit, etc.

The location of the proxy UDR system 200 may depend upon the network architecture. As set forth above, the proxy UDR system 200 may be located in the core network 102, in a separate processing node, or in multiple locations. Further, although shown as a single integrated system, the functions of proxy UDR system 200 may be separated and be disposed in separate locations.

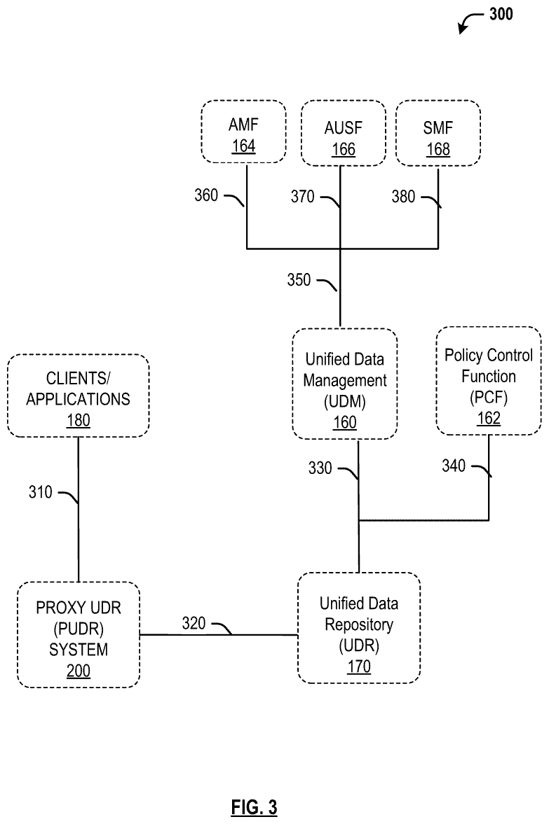

FIG. 3 depicts an environment 300 showing a proxy UDR system 200 operating within a network. As illustrated, network functions such as access and mobility function (AMF) 164, an authentication server function (AUSF) 166, and a session management function (SMF) 168 communicate over interfaces 360, 370, and 380 respectively to access the UDM 160 over an interface 350. The UDM 160 access the UDR 170 over an interface 330 and a policy control function (PCF) 162 accesses the UDR 170 over an interface 340. The interfaces 330, 340, 350, 360, 370, and 380 are 3GPP defined interfaces allowing access to the UDR 170.

Embodiments set forth herein introduce the proxy UDR system 200, connected to the UDR 170 by API 320 and connected to clients or applications using an API 310. Accordingly, the clients or applications 180 may send a request using the API 310 to the proxy UDR system 200. The proxy UDR system 200 accesses the UDR 170 over API 320 and performs processing as specified above in order to fulfill the request. The API 310 and the API 320 may be or include one or more of a lightweight directory access protocol (LDAP) API and/or a hypertext transfer protocol version two (HTTP2) representation state transfer (REST) API. Further, in some embodiments, the UDR 170 pushes notifications to the proxy UDR system 200 while in other embodiments, the proxy UDR system 200 pulls subscriber information from the UDR 170 and transmits the information to the client or application 180, which may be external to the network 102.

All of the illustrated network functions can include a processor, a memory, and may be configured to perform the various functions described herein. Further, each network function can associate with different reference points, including reference points for data transmission between different network nodes and reference points for control signal transmission between different network nodes.

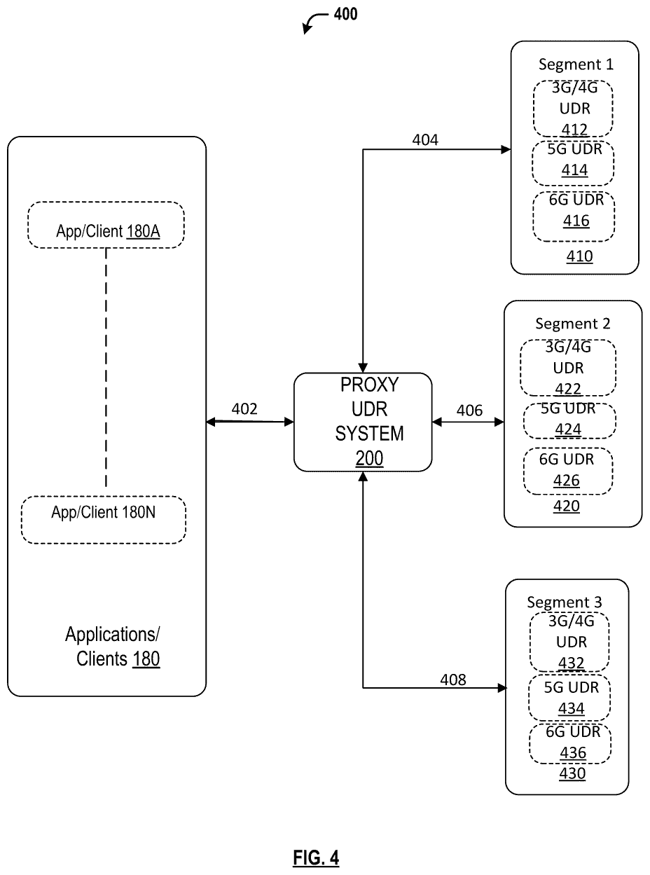

FIG. 4 depicts an environment 400 showing a proxy UDR system 200 operating within a network. Applications or clients 180 may access the proxy UDR system 200 over an interface 402. The interface 402 is not defined by 3GPP standards and may include, for example, an LDAP or a HTTP/2 REST API.

Further, the proxy UDR system 200 may process a request from the applications or clients 180 by accessing UDR segments 410, 420, and 430 over corresponding APIs 404, 406, and 408. The APIs 404, 406, 408 are not defined by 3GPP standards and may be or include, for example, an LDAP or a HTTP/2 REST API. In some cases, the proxy UDR system 200 will pull information from the UDR segments 410, 420, and 430 in response to a request from an application 180. In other instances, such as in the case of a database update that an application or client 180 subscribes to, an HTTP push notification can be utilized to transmit information to the proxy UDR system 200. Similarly, the proxy UDR system 200 may send an HTTP/2 push notification to the application or client 180.

In the illustrated embodiment, each segment 410, 420, 430 includes UDRs from multiple RATs. The first segment 410 includes a 3G/4G UDR 412, a 5G UDR 414, and a 6G UDR 416. The second segment 420 includes a 3G/4G UDR 422, a 5G UDR, 424, and a 6G UDR 426. Finally, the segment 430 includes a 3G/4G UDR 432, a 5G UDR 434, and a 6G UDR 436.

Thus, the proxy UDR system 200 accesses multiple UDR segments 410, 420, and 430. Further, the proxy UDR system 200 accesses each segment over a corresponding API 404, 406, and 408. In some embodiments, the multiple UDRs correspond to different radio access technologies (RATs).

As illustrated, the proxy UDR system 200 performs segment routing by routing incoming LDAP and HTTP/2 requests to a targeted segment 410, 420, 430 based on the client or application 180, request type (HTTP or LDAP), or subscriber identity type. In the case of LDAP requests, the routing may also be based on the distinguished name (DN) suffix in the case of the LDAP proxy flows. Many supported identities may be configured for identifying subscriber records including-unique database identifier (UID); international mobile subscriber identity (IMSI); mobile station international subscriber directory number(MSISDN) ; Internet protocol multimedia private identity (IMPI); Internet protocol multimedia public identity (IMPU); generic public subscription identifier (GPSI); subscription permanent identifier (SUPI); international mobile equipment identity (IMEI)/permanent equipment identifier (PEI); and CustomerID.

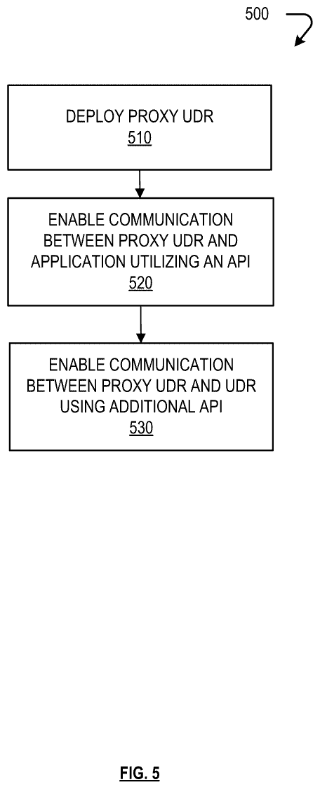

FIG. 5 depicts a method 500 for utilizing a proxy UDR system 200 in accordance with an embodiment. Method 500 may be performed by any suitable processor discussed herein, for example, the processor 210 included in the proxy UDR system 200 and/or a processor included in the core network 102 or separate processing node.

Method 500 starts in step 510, in which the network deploys the proxy UDR system 200 for facilitating communication between an application or client 180 and a UDR of the network. The proxy UDR may be deployed in response to a request for resources from an external application or client. Alternatively, the proxy UDR system 200 may be deployed in response a database update performed within the UDR 170.

In step 520, the proxy UDR system 200 enables communication with the application or client 180 by utilizing an API such as an LDAP and/or a REST HTTP/2 API. Further, in step 530, the proxy UDR system 200 enables communication with the UDR using one or more additional APIs, which may be an LDAP and/or a REST HTTP/2 API.

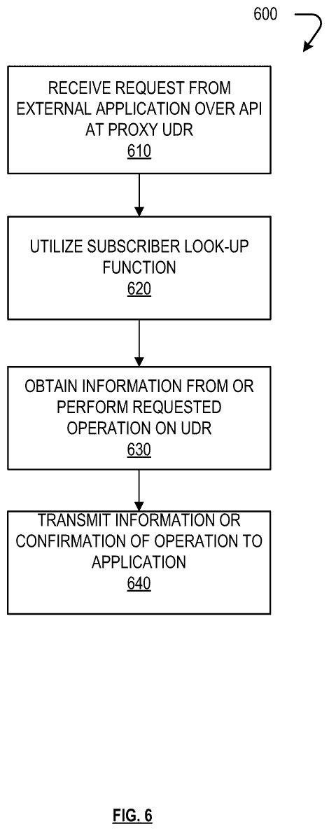

FIG. 6 depicts an additional exemplary method 600 for processing a request from a client or application 180 utilizing the proxy UDR system 200 to access the UDR 170. Method 600 may be performed by any suitable processor discussed herein, for example, the processor 210 in the proxy UDR system 200, which may be wholly or partially incorporated in the core network 102 or in a separate processing node. For discussion purposes, as an example, method 600 is described as being performed by the processor 210 included in the proxy UDR system 200.

In step 610, the processor 210 receives a request from an application or client 180, which may be an external application or client. The request may be received, for example over an LDAP API or an HTTP/2 REST API. A first set of services may be offered over the LDAP API and a second set of services may be offered over the HTTP/2 REST API. The first set of services may be or include LDAP authentication, binding, unbinding, LDAP search, LDAP modify, LDAP add, and LDAP delete operations. The second set of services offered over the HTTP/2 REST API may be or include get, put, patch, post, and delete.

Upon receiving the request in step 610, the processor 210 utilizes a subscriber look up function in step 620 to locate subscriber information in the UDR 170. As set forth above, the proxy UDR system 200 may search multiple segments of the UDR 170.

In step 630, upon performing the subscriber look up, the processor 210 obtains requested information or performs requested operations for the requestor from the UDR 170 as set forth in the received request. The information may be obtained or the requested operation may be performed, for example, over an LDAP API or an HTTP/2 REST API. The information may be or include, for example, one or more fields of location information. Finally, in step 640, the processor 210 triggers transmission of the requested information or confirmation of the operation to the application or client 180. More specifically, the proxy UDR system 200 may pull subscriber information from the UDR and transmits the subscriber information to the application or client 180, which may be external to the network.

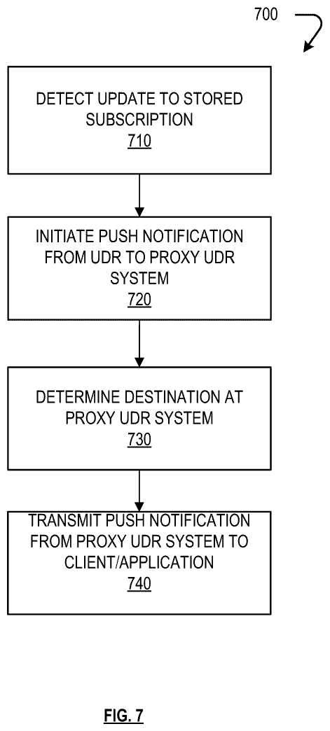

FIG. 7 illustrates a method 700 illustrating operation of the proxy UDR system 200 during a database update at the UDR 170. Method 700 may be performed by multiple processors, for example a processor at the UDR 170 and the processor 210 in the proxy UDR system 200, which may be wholly or partially incorporated in the core network 102 or in a separate processing node.

In step 710, the UDR detects an update to the database related to a subscriber associated with a stored subscription. In step 720, the UDR may initiate a push notification to the proxy UDR system 200. The push notification may occur, for example, as a simple object access protocol (SOAP) over HTTP or as an HTTP/2 push notification over an LDAP API or HTTP/2 REST API. Thus, the UDR 170 pushes notifications to the proxy UDR system 200 upon detecting updates related to a subscription.

In step 730, the processor 210 processes the push notification and determines its destination and in step 740 transmits the push notification from the proxy UDR system 200 to the client or application 180, which may be external to the network. As set forth above, the push notification may occur, for example as a SOAP over HTTP or as an HTTP/2 push notification over an LDAP API or an HTTP/2 REST API. Thus, the proxy UDR system 200 operates as a gateway for UDR initiated push notifications to applications or clients, which may be external to the network.

In some embodiments, methods 500, 600, and 700 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 500, 600, and 700 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
deploying a proxy unified data repository (UDR) system facilitating communication between an application and a UDR within a network;
enabling communication between the proxy UDR system and the application using an application program interface (API); and
enabling communication between the proxy UDR system and the UDR using at least an additional API.

2. The method of claim 1, wherein the API or the additional API comprises a hypertext transfer protocol version two (HTTP2) representational state transfer (REST) API.

3. The method of claim 1, wherein the API or the additional API comprises a lightweight directory access protocol (LDAP) API.

4. The method of claim 1, further comprising providing a subscriber look up function within the proxy UDR system that obtains subscriber information from the UDR.

5. The method of claim 1, wherein the proxy UDR system accesses multiple UDR segments of the UDR.

6. The method of claim 5, wherein the proxy UDR system accesses each segment of the UDR over a corresponding additional API.

7. The method of claim 1, wherein the proxy UDR system communicates with multiple segments of the UDR, wherein each of the multiple segments is accessed over a corresponding additional API.

8. The method of claim 1, further comprising accessing multiple UDRs that include the UDR from the proxy UDR, wherein the multiple UDRs correspond to different radio access technologies (RATs).

9. The method of claim 1, wherein the proxy UDR system pulls subscriber information from the UDR and transmits the subscriber information to the application, wherein the application is external to the network.

10. The method of claim 1, wherein the UDR pushes notifications to the proxy UDR system.

11. The method of claim 10, wherein the proxy UDR system transmits push notifications to the application, wherein the application is external to the network.

12. The method of claim 11, wherein the application is one or more of policy functions, voicemail routing (VMR), gateway mobile location center (GMLC), device query interface (DQI), or network application publisher (NAP).

13. A system comprising:
a proxy unified data repository (UDR) system facilitating communication between an application external to a network and a UDR;
an application program interface (API) enabling communication between the proxy UDR system and the application external to the network; and
an additional API enabling communication between the proxy UDR system and the UDR.

14. The system of claim 13, wherein the API or the additional API comprises a lightweight directory access protocol (LDAP) API or a hypertext transfer protocol version two (HTTP2) API.

15. The system of claim 13, wherein the proxy UDR system further comprises a subscriber look up function that obtains subscriber information from the UDR.

16. The system of claim 13, further comprising a corresponding additional API facilitating communication between the proxy UDR system and each of multiple segments of the UDR.

17. The system of claim 13, wherein the UDR is one of multiple UDRs, wherein the multiple UDRs correspond to different radio access technologies (RATs).

18. A system comprising:
a proxy unified data repository (UDR) system facilitating communication between an application external to a network and a UDR;
a lightweight directory access protocol (LDAP) application program interface (API) providing a first set of services for the application external to the network; and
a hypertext transfer protocol version two (HTTP2) API providing a second set of services for the application external to the network.

19. The system of claim 18, wherein the first set of services comprises LDAP authentication, binding, unbinding, LDAP search, LDAP modify, LDAP add, and LDAP delete operations and the second set of services comprises HTTP methods including get, put, patch, post, and delete.

20. The system of claim 18, wherein the UDR proxy operates as a gateway for UDR initiated push notifications toward the application external to the network.
